(19) United States
(12) Patent Application Publication
(10) Pub. No.: US 2024/0060600 A1
(43) Pub. Date: Feb. 22, 2024

(54) OIL CIRCULATION SYSTEM

(71) Applicant: YANTAI JEREH PETROLEUM EQUIPMENT & TECHNOLOGIES CO., LTD., Yantai (CN)

(72) Inventors: Sheng CHANG, Yantai (CN); Shanwu FU, Yantai (CN); Xiaoyu FENG, Yantai (CN); Chuanbo WANG, Yantai (CN); Kaishen LIU, Yantai (CN); Chunqiang LAN, Yantai (CN); Chenjun LIU, Yantai (CN)

(21) Appl. No.: 18/307,239

(22) Filed: Apr. 26, 2023

(30) Foreign Application Priority Data
Aug. 18, 2022 (CN) 202222179952.7

(51) Int. Cl. F16N 7/38; F16N 29/04; F16N 39/04; F16N 39/06

(52) U.S. Cl. CPC F16N 7/385; F16N 29/04; F16N 39/04; F16N 39/06; F16N 2250/36; F16N 2200/04; F16N 2200/20

(57) ABSTRACT

An oil circulation system is configured to supply lubrication oil to a plunger pump. The oil circulation system includes an oil tank, and the oil tank is provided with an electric heater. The oil circulation system further includes: a main circulation circuit. Two ends of the main circulation circuit are configured to respectively communicate with an oil outlet and an oil inlet of the oil tank, and the main circulation circuit is provided with a power member; and an overflow valve, disposed on the main circulation circuit and located on an oil outflow side of the power member.

### CROSS-REFERENCE TO RELATED APPLICATIONS

The present application claims priority to Chinese Patent Application No. 202222179952.7, filed on Aug. 18, 2022 and entitled “Oil Circulation System”, the content of which is hereby incorporated by reference in its entirety.

### TECHNICAL FIELD

The present disclosure relates to a technical field of plunger pump lubrication, in particular to an oil circulation system.

### BACKGROUND

Fracturing is an important measure to increase oil production and efficiency, and a main function of it is to improve an infiltrability of an oil layer. A key device in the fracturing operation process is a fracturing device. At present, the existing fracturing device may be a diesel-driven fracturing device or an electric-driven fracturing device. Based on requirements for increased high environmental protection and the drawbacks of the diesel-driven fracturing device that occupies a large area, is heavy, inconvenient to transport, noisy, not environment-friendly, and has a high operating cost and the like, the electric-driven fracturing device is already used as a mainstream fracturing device to participate in fracturing construction operations.

A core member of the electric-driven fracturing device for construction operations is a plunger pump. In order to achieve the fracturing construction operations of low-pressure suction and high-pressure discharge of the plunger pump, a lubrication system is required to lubricate and cool a power member of the plunger pump. A working medium of the lubrication system is generally lubricating oil. In a fracturing operation, the plunger pump needs to discharge a certain pressure of fracturing fluid, and the plunger pump bears a working load.

Under extremely cold conditions, the lubricating oil needs to be heated before the plunger pump works. After the lubricating oil is heated to a suitable temperature, the plunger pump can work, and the lubricating oil can have a good viscosity, so a good lubricating effect is achieved. A service life of the plunger pump is prolonged, and an abrasion of the plunger pump in an using process is reduced. The existing electric-driven fracturing device uses an electric heater added inside a lubricating oil tank for heating. Due to a poor thermal conductivity of the lubricating oil, this heating mode may cause a localized high temperature of the lubricating oil, so that the lubricating oil is deteriorated and ineffective. The heating time is too long, the heating effect is poor, and it is impossible to guarantee that a temperature of the lubricating oil can reach the suitable temperature before the plunger pump works, so it is easy to cause an increased abrasion of the plunger pump. And if the heating time is longer, a longer waiting time for heating is required.

In addition, particles are generated by the abrasion of the power member and enter the lubricating oil, and the lubricating oil may also be contaminated with water vapor in the work so that the lubricating oil is deteriorated and emulsified. After a certain period of the work, the lubricating oil may be deteriorated, and the lubricating oil and a lubricating filter element need to be replaced.

### SUMMARY

Some embodiments of the present disclosure provide an oil circulation system, which solves the above technical problems that the oil quality is unknown and the oil heating effect is poor in the oil circulation system.

In order to achieve the above purpose, some embodiments of the present disclosure provide an oil circulation system, which is configured to supply lubrication oil to a plunger pump. The oil circulation system includes an oil tank, and the oil tank is provided with an electric heater. The oil circulation system further includes: a main circulation circuit, wherein two ends of the main circulation circuit are configured to respectively communicate with an oil outlet and an oil inlet of the oil tank, and the main circulation circuit is provided with a power member; and an overflow valve disposed on the main circulation circuit and located on an oil outflow side of the power member.

In some embodiments, the oil circulation system further includes: a detector configured to detect a quality of lubrication oil in the main circulation circuit. At least part of the detector is disposed in the main circulation circuit.

In some embodiments, the oil circulation system further includes: a pipeline heater, disposed on the main circulation circuit or in contact with the main circulation circuit, wherein the pipeline heater is disposed on an outlet end of the overflow valve and configured to heat the lubrication oil in the main circulation circuit.

In some embodiments, the oil circulation system further includes: a filter member, disposed on the main circulation circuit and configured to communicate with the main circulation circuit, wherein the filter member is located between the power member and the overflow valve, and the detector is disposed between the power member and the filter member, or the detector is disposed between the filter member and the overflow valve.

In some embodiments, the oil inlet of the oil tank includes a first oil inlet and a second oil inlet, the main circulation circuit is configured to communicate with the first oil inlet, and the oil circulation system further includes: a lubrication branch circuit, wherein two ends of the lubrication branch circuit are configured to respectively communicate with the main circulation circuit and the second oil inlet, and the plunger pump is disposed on the lubrication branch circuit.

In some embodiments, the detector is disposed on an oil inflow side of the power member, or the detector is disposed on the oil outflow side of the power member.

In some embodiments, the oil circulation system further includes: an alarm member, connected with the detector, wherein the alarm member receives quality information of the lubrication oil obtained by the detector, and judges whether to issue an alarm according to the quality information.

In some embodiments, the oil circulation system further includes: a lubrication branch circuit, disposed in parallel with the main circulation circuit, wherein an oil outflow port of the lubrication branch circuit and an oil outflow port of the main circulation circuit are configured to communicate with the plunger pump, and an oil outlet of the plunger pump is configured to communicate with the oil tank.

In some embodiments, the main circulation circuit and the lubrication branch circuit are coupled with the power member, and the power member is a lubrication pump; and at least part of the detector is disposed in the lubrication branch circuit.

In some embodiments, the oil circulation system further includes: a controller, wherein the overflow valve, the detector and the power member are all connected with the controller.

In some embodiments, the power member includes: a pump body, disposed on the main circulation circuit and configured to communicate with the main circulation circuit; and a driving member, herein the driving member is connected with the pump body, and the pump body is driven to run by the driving member.

In the techniques disclosed herein, during the use process, the power member obtains the oil from the oil tank, and an oil pressure is established by adjusting the overflow valve. By adjusting an opening pressure of the overflow valve, the power member is adjusted to do work on the oil, to provide heat energy to the oil, thereby the heating of the oil is achieved. further, while the oil is flowed through the main circulation circuit, it is in contact with the detector, such that the detector can detect data such as metal particles, moisture, saturation and viscosity of the oil and feedback the detected oil information to the control system, which can remind an operator to check and replace the oil in time.

### BRIEF DESCRIPTION OF THE DRAWINGS

Drawings of the description for constituting a part of the present application are used to provide further understanding of the present disclosure, and schematic embodiments of the present disclosure and descriptions thereof are used to explain the present disclosure, and do not limit the present disclosure. In the drawings:

FIG. 1 illustrates a structure schematic diagram of an example oil circulation system according to an embodiment of the present disclosure.

FIG. 2 illustrates a structure schematic diagram showing a heating state of lubricating oil in the oil circulation system according to an embodiment of the present disclosure.

FIG. 3 illustrates a structure schematic diagram showing another heating state of the lubricating oil in the oil circulation system according to an embodiment of the present disclosure.

FIG. 4 illustrates a structure schematic diagram showing a lubricating state of a plunger pump in the oil circulation system according to an embodiment of the present disclosure.

FIG. 5 illustrates a structure schematic diagram showing an oil quality detection state in the oil circulation system according to an embodiment of the present disclosure.

FIG. 6 illustrates a structure schematic diagram showing another oil quality detection state in the oil circulation system according to an embodiment of the present disclosure.

FIG. 7 illustrates a structure schematic diagram showing another oil quality detection state in the oil circulation system according to an embodiment of the present disclosure.

FIG. 8 illustrates a schematic diagram of a work flow of a quality detector in the oil circulation system according to an embodiment of the present disclosure.

Herein, the above drawings include the following reference labels:
100. Plunger pump; 200. Oil tank; 201. First oil inlet; 202. Second oil inlet; 300. Electric heater; 1. Main circulation circuit; 10. Power member; 2. Overflow valve; 3. Quality detector; 4. Pipeline heater; 5. Filter member; 6. Lubrication branch circuit; 7. Controller; 11. Pump body; 12. Driving member; 8. Radiator.

### DETAILED DESCRIPTION OF THE EMBODIMENTS

It should be noted that embodiments in the present application and features of the embodiments may be combined with each other in the case without conflicting. The present disclosure is described in detail below with reference to the drawings and in combination with the embodiments.

At present, the lubricating oil of the electric-driven fracturing device lacks oil quality detection, and the replacement of the lubricating oil depends on the subjective judgment of an operator completely, or according to the use time of the device, or according to the experience of personnel. The lubricating oil may be replaced too soon or too late, so that the lubricating oil is wasted or the plunger pump is damaged, and the entire electric-driven fracturing device may not be normally operated. The construction efficiency is low, and the device operation efficiency and the construction progress are affected.

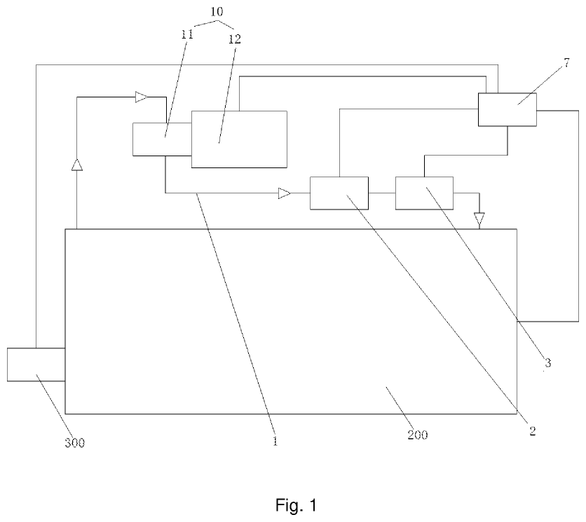

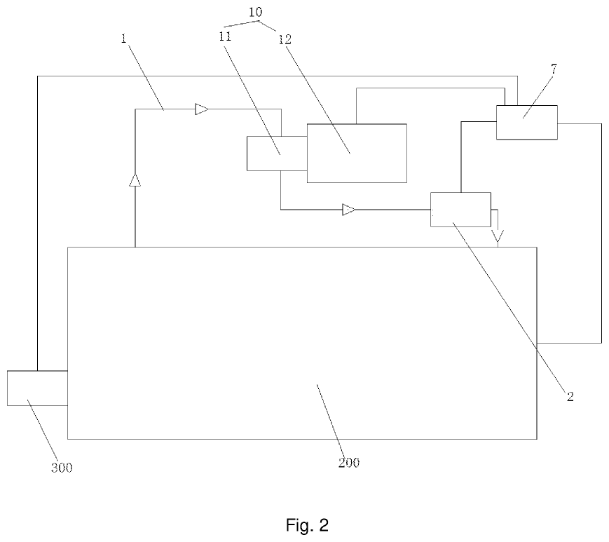

With reference to FIG. 1 to FIG. 7, some embodiments of the present disclosure provides an oil circulation system, configured to supply oil to a plunger pump 100, wherein the oil circulation system includes an oil tank 200, and the oil tank 200 is provided with an electric heater 300, wherein the oil circulation system further includes: a main circulation circuit 1, wherein two ends of the main circulation circuit 1 are configured to respectively communicate with an oil outlet and an oil inlet of the oil tank 200, and the main circulation circuit 1 is provided with a power member 10; an overflow valve 2, disposed on the main circulation circuit 1 and located on an oil outflow side of the power member 10; and a quality detector 3, wherein at least part of the quality detector 3 is disposed in the main circulation circuit 1, and configured to detect a quality of the lubrication oil in the main circulation circuit 1.

The oil circulation system provided according to the present disclosure is used for supplying the oil to the plunger pump 100. The oil circulation system includes an oil tank 200, and the oil tank 200 is provided with an electric heater 300. The oil circulation system further includes: a main circulation circuit 1, wherein two ends of the main circulation circuit 1 are configured to respectively communicate with an oil outlet and an oil inlet of the oil tank 200, and the main circulation circuit 1 is provided with a power member 10; the main circulation circuit 1 is further provided with an overflow valve 2 and a quality detector 3, and the overflow valve 2 is disposed on the main circulation circuit 1 and located on an oil outflow side of the power member 10; and at least part of the quality detector 3 is disposed in the main circulation circuit 1, and the quality of the oil in the main circulation circuit 1 is detected by the quality detector 3. In this way, when the system is in use, the power member 10 obtains the oil from the oil tank 200, and an oil pressure is established by adjusting the overflow valve 2. By adjusting an opening pressure of the overflow valve 2, the power member 10 is adjusted to do work on the oil, to provide heat energy to the oil, thereby the heating of the oil is achieved. Further, while the oil is flowed through the main circulation circuit 1, it is in contact with the quality detector 3, such that the detector can detect data such as metal particles, moisture, saturation and viscosity of the oil and feedback the detected oil information to the control system, which can remind an operator i to check and replace the oil in time.

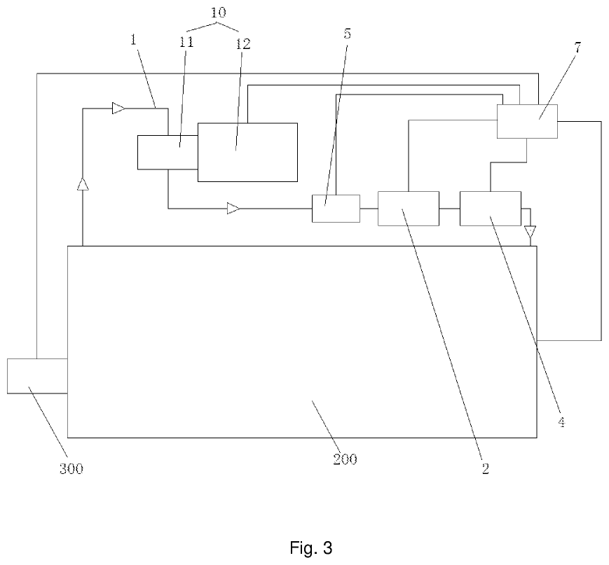

In some embodiments, as shown in FIG. 3, the oil circulation system further includes: a pipeline heater 4, disposed on the main circulation circuit 1 or in contact with the main circulation circuit 1, wherein the pipeline heater 4 is disposed on an outlet end of the overflow valve 2, and configured to heat the oil in the main circulating circuit 1. The oil flowing out of the overflow valve 2 is flowed back to the oil tank 200 after being heated by the pipeline heater 4. When the pipeline heater 4 is disposed on the main circulation circuit 1, the pipeline heater 4 is configured to communicate with a pipeline of the main circulation circuit 1.

In some embodiments, the oil circulation system further includes: a filter member 5, disposed on the main circulation circuit 1 and configured to communicate with the main circulation circuit 1, wherein the filter member 5 is located between the power member 10 and the overflow valve 2, the quality detector 3 is disposed between the power member 10 and the filter member 5, or the quality detector 3 is disposed between the filter member 5 and the overflow valve 2. The oil is filtered and cleaned by the filter member 5, and the use time of the oil is increased. The filter member 5 can achieve a differential pressure alarm. While the filter member 5 is used for a long time and a blocking state of a filter element is detected by a detector at the filter member 5, the differential pressure alarm can be triggered at the filter member 5 to send a single, the control system receives the signal to provide/display an alarm to remind a device operator to replace the filter element in time, so an automatic reminding function of the replacement of the filter member 5 is achieved.

In this embodiment, the power member 10 is a circulation pump, and the circulation pump is a gear pump or a plunger pump or a vane pump or a rotor pump or a pneumatic pump or the like. While the circulation pump is the gear pump or the plunger pump or the vane pump or the rotor pump, it is driven by a motor; and while the circulation pump is the pneumatic pump, it is driven by connecting to an air source, and the air source is externally connected or provided by an air circuit system on a device body.

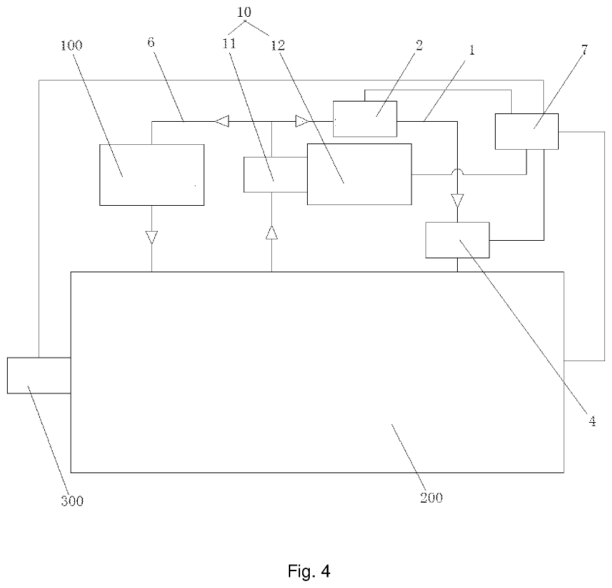

As shown in FIG. 4, in a second embodiment provided by the present disclosure, the oil inlet of the oil tank 200 includes a first oil inlet 201 and a second oil inlet 202, the main circulation circuit 1 is configured to communicate with the first oil inlet 201, and the oil circulation system further includes: a lubrication branch circuit 6, herein two ends of the lubrication branch circuit 6 are configured to respectively communicate with the main circulation circuit 1 and the second oil inlet 202, and the plunger pump 100 is disposed on the lubrication branch circuit 6. In this embodiment, the power member 10 on the main circulation circuit 1 is a lubrication pump.

One route of an outlet of the lubrication pump, the lubricating oil is supplied to the plunger pump 100 by the lubrication branch circuit 6, as to guarantee the good lubrication of internal elements of the plunger pump 100; the other route of the outlet of the lubrication pump is returned to the oil tank 200 by the overflow valve 2, the overflow valve 2 is manual or electric and other forms (the overflow valve is in the form of a throttle valve, a ball valve and the like), the overflow valve is establish an oil pressure, it is that the lubrication pump can do work on the lubricating oil, as to convert into heat energy of the lubricating oil, thereby the heating of the lubricating oil is achieved; the outlet of the overflow valve 2 is further additionally provided with the pipeline heater 4, the lubricating oil is further heated by the pipeline heater 4, and the heating efficiency is improved; the control system achieves the automatic start and stop of a heating system by detecting the temperature of the lubricating oil; while the heating system is started, the overflow valve 2 is opened to establish the oil pressure, and the lubricating oil is heated; and while the heating system is stopped, the overflow valve 2 is closed, this route of the heating system is turned off, and the lubricating oil is not heated.

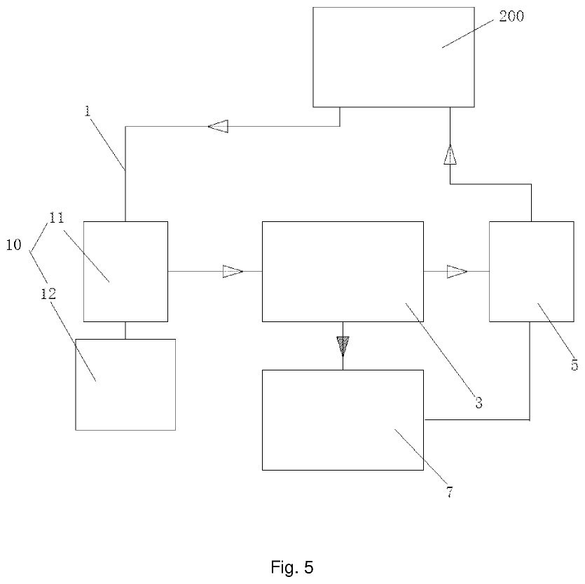

During the specific implementation, as shown in FIG. 5, the quality detector 3 is disposed on an oil inflow side of the power member 10, or the quality detector 3 is disposed on the oil outflow side of the power member 10. While the quality detector 3 is disposed on the oil inflow side of the power member 10, the sufficient oil volume can be guaranteed, and the detection structure is more accurate and reliable; and while the quality detector 3 is disposed on the oil outflow side of the power member 10, the quality detector 3 does not bear the pressure, so the service life of the quality detector 3 is improved, and it is not easy to be damaged.

In order to easily remind the operator of the quality information of the oil, the oil circulation system further includes: an alarm member, connected with the quality detector 3, wherein the alarm member receives quality information detected by the quality detector 3, and judges whether to issue an alarm according to the quality information.

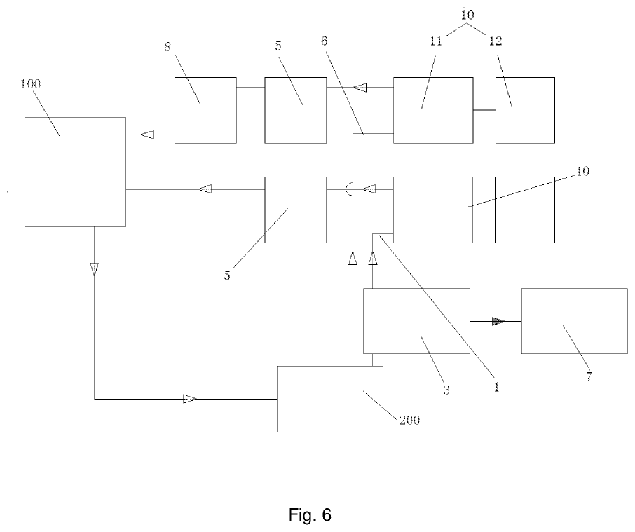

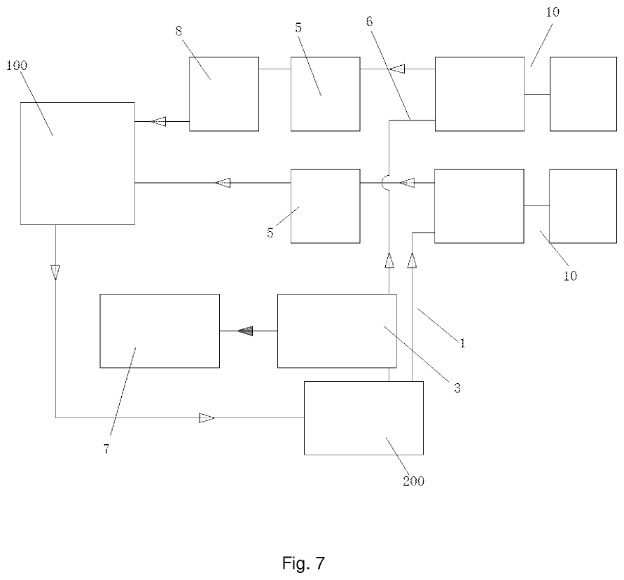

As shown in FIG. 6 and FIG. 7, the oil circulation system further includes: a lubrication branch circuit 6, disposed in parallel with the main circulation circuit 1, herein an oil outflow port of the lubrication branch circuit 6 and an oil outflow port of the main circulation circuit 1 are configured to communicate with the plunger pump 100, and an oil outlet of the plunger pump 100 is configured to communicate with the oil tank 200. Wherein, the lubrication branch circuit 6 and the main circulation circuit 1 are both provided with the filter member 5 to filter the oil in the lubrication branch circuit 6 and the main circulation circuit 1, the lubrication branch circuit 6 is provided with a radiator 8, and the radiator 8 is located on an oil inlet side of the plunger pump 100 to dissipate heat of the oil while the temperature of the oil is too high.

The main circulation circuit 1 and the lubrication branch circuit 6 are coupled with the power members 10, and the power member 10 is a lubrication pump; and at least part of the quality detector 3 is disposed in the lubrication branch circuit 6. In this embodiment, the quality detector 3 is disposed on the main circulation circuit 1 or the lubrication branch circuit 6. The independent lubrication pumps and power sources, and the pipelines are reduced, the device cost is reduced, the number of device members is reduced, the space utilization rate of the device is higher, and the integration degree is higher.

In this embodiment, in order to control each member in the oil circulation system, the oil circulation system further includes: a controller 7, wherein the overflow valve 2, the quality detector 3 and the power member 10 are all connected with the controller 7. The oil detection system achieves the real-time detection of the quality of the lubricating oil, and according to an alarm threshold value, while an oil parameter reaches the alarm threshold value, the control system can give an alarm and remind the operator to replace the lubricating oil. The lubricating oil can be replaced in time, and the damage to the plunger pump, a core member, of the electric-driven fracturing device can be avoided. It can also avoid the waste of lubricating oil and the increase in the construction operation cost caused by prematurely replacing the lubricating oil; and it can reduce the cost and increase the efficiency in construction operations, and achieve the intelligent maintenance of lubricating oil in a device.

The power member 10 includes: a pump body 11, disposed on the main circulation circuit 1 and configured to communicate with the main circulation circuit 1; and a driving member 12, wherein the driving member 12 is connected with the pump body 11, and the pump body 11 is driven to run by the driving member 12. In this embodiment, the driving member 12 may be electric drive or air source drive. When the circulation pump is driven by an air source, a problem of insufficient power of a power supply can be solved. When the circulation pump is driven by a motor, the power supply of the device itself can be directly used to provide the power.

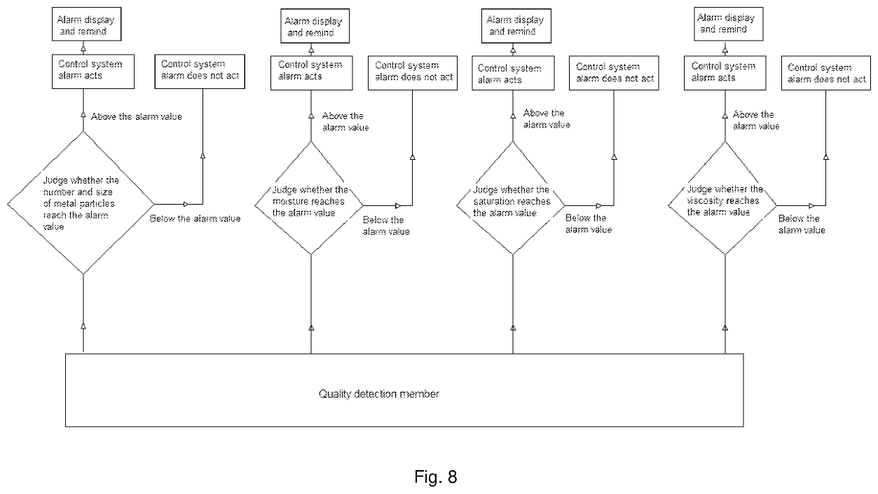

As shown in FIG. 8, the quality detector 3 is configured to detect the quality information (data such as metal particles, moisture, saturation, and viscosity of the lubricating oil), and feedback the data to a device control system, and the device control system can display the data such as the number and size of the metal particles, the moisture, the saturation and the viscosity in real time, and judge whether the alarm threshold value is reached in real time (the alarm threshold value can be set, and the setting of the alarm threshold value can be performed according to different brands and models of the lubricating oil). After the alarm threshold value is reached, the device control system displays an alarm message to remind the device operator to check and replace the oil in time.

In this embodiment of the present disclosure, the quality detector 3 may be an oil monitoring sensor. During the process in which the oil is flowed through the oil monitoring sensor, the oil monitoring sensor analyzes the quality information of the oil and transmits the quality information of the oil to the device control system.

From the above descriptions, it may be seen that the above embodiments of the present disclosure achieve the following technical effects.

The oil circulation system provided according to the present disclosure is used for supplying oil to a plunger pump 100, the oil circulation system includes an oil tank 200, and the oil tank 200 is provided with an electric heater 300, wherein the oil circulation system further includes: a main circulation circuit 1, wherein two ends of the main circulation circuit 1 are configured to respectively communicate with an oil outlet and an oil inlet of the oil tank 200, and the main circulation circuit 1 is provided with a power member 10; the main circulation circuit 1 is further provided with an overflow valve 2 and a quality detector 3, and the overflow valve 2 is disposed on the main circulation circuit 1 and located on an oil outflow side of the power member 10; and at least part of the quality detector 3 is disposed in the main circulation circuit 1, and the quality of the oil in the main circulation circuit 1 is detected by the quality detector 3. In this way, during the use process, the power member 10 obtains the oil from the oil tank 200, and an oil pressure is established by adjusting the overflow valve 2. By adjusting an opening pressure of the overflow valve 2, the power member 10 is adjusted to do work on the oil, to provide heat energy to the oil, thereby the heating of the oil is achieved. Further, while the oil is flowed through the main circulation circuit 1, it is in contact with the quality detector 3, such that the detector can detect data such as metal particles, moisture, saturation and viscosity of the oil and feedback the detected oil information to the device control system to remind the operator to check and replace the oil in time.

The above descriptions are only preferred embodiments of the present disclosure, and are not intended to limit the present disclosure. For those skilled in the art, the present disclosure may have various modifications and changes. Any modifications, equivalent replacements, improvements and the like made within the spirit and principle of the present disclosure shall be included in a scope of protection of the present disclosure.

What is claimed is:

1. An oil circulation system, configured to supply lubrication oil to a plunger pump, the oil circulation system comprising:
an oil tank having an electric heater, an oil outlet, and an oil inlet;
a main circulation circuit, wherein two ends of the main circulation circuit are configured to respectively communicate with the oil outlet and the oil inlet of the oil tank, and the main circulation circuit is provided with a power member; and
an overflow valve, disposed on the main circulation circuit and located on an oil outflow side of the power member.

2. The oil circulation system of claim 1, further comprising: a detector configured to detect a quality of the lubrication oil in the main circulation circuit, wherein at least part of the detector is disposed in the main circulation circuit.

3. The oil circulation system of claim 2, further comprising:
a pipeline heater, disposed on the main circulation circuit or in contact with the main circulation circuit, wherein the pipeline heater is disposed on an outlet end of the overflow valve and configured to heat the lubrication oil in the main circulation circuit.

4. The oil circulation system of claim 3, further comprising:
a filter member, disposed on the main circulation circuit and configured to communicate with the main circulation circuit, wherein the filter member is located between the power member and the overflow valve, and
the detector is disposed between the power member and the filter member, or the detector is disposed between the filter member and the overflow valve.

5. The oil circulation system of claim 2, wherein the oil inlet of the oil tank comprises a first oil inlet and a second oil inlet, the main circulation circuit is configured to communicate with the first oil inlet, and the oil circulation system further comprises:
a lubrication branch circuit, wherein two ends of the lubrication branch circuit are configured to respectively communicate with the main circulation circuit and the second oil inlet, and the plunger pump is disposed on the lubrication branch circuit.

6. The oil circulation system of claim 2, wherein the detector is disposed on an oil inflow side of the power member, or
the detector is disposed on the oil outflow side of the power member.

7. The oil circulation system of claim 2, further comprising:
an alarm member connected with the detector, wherein the alarm member receives quality information of the lubrication oil obtained by the detector, and judges whether to issue an alarm according to the quality information.

8. The oil circulation system of claim 2, further comprising:
a lubrication branch circuit disposed in parallel with the main circulation circuit, wherein an oil outflow port of the lubrication branch circuit and an oil outflow port of the main circulation circuit are configured to communicate with the plunger pump, and an oil outlet of the plunger pump is configured to communicate with the oil tank.

9. The oil circulation system of claim 7, wherein the main circulation circuit and the lubrication branch circuit are coupled with the power member, and the power member is a lubrication pump; and
at least part of the detector is disposed in the lubrication branch circuit.

10. The oil circulation system of claim 2, further comprising:
a controller, wherein the overflow valve, the detector, and the power member are connected with the controller.

11. The oil circulation system of claim 1, wherein the power member comprises:
a pump body disposed on the main circulation circuit and configured to communicate with the main circulation circuit; and
a driving member, wherein the driving member is connected with the pump body, and the pump body is driven to run by the driving member.

12. The oil circulation system of claim 3, further comprising:
a controller, wherein the overflow valve, the detector, and the power member are connected with the controller.

13. The oil circulation system of claim 4, further comprising:
a controller, wherein the overflow valve, the detector, and the power member are connected with the controller.

14. The oil circulation system of claim 5, further comprising:
a controller, wherein the overflow valve, the detector, and the power member are connected with the controller.

15. The oil circulation system of claim 6, further comprising:
a controller, wherein the overflow valve, the detector, and the power member are connected with the controller.

16. The oil circulation system of claim 8, further comprising:
a controller, wherein the overflow valve, the detector, and the power member are connected with the controller.

17. The oil circulation system of claim 9, further comprising:
a controller, wherein the overflow valve, the detector, and the power member are connected with the controller.

18. The oil circulation system of claim 2, wherein the power member comprises:
a pump body, disposed on the main circulation circuit and configured to communicate with the main circulation circuit; and
a driving member, wherein the driving member is connected with the pump body, and the pump body is driven to run by the driving member.

19. The oil circulation system of claim 3, wherein the power member comprises:
a pump body, disposed on the main circulation circuit and configured to communicate with the main circulation circuit; and
a driving member, wherein the driving member is connected with the pump body, and the pump body is driven to run by the driving member.

20. The oil circulation system of claim 4, wherein the power member comprises:
a pump body, disposed on the main circulation circuit and configured to communicate with the main circulation circuit; and
a driving member, wherein the driving member is connected with the pump body, and the pump body is driven to run by the driving member.
